(19) United States
(12) Patent Application Publication
(10) Pub. No.: US 2006/0239577 A1
(43) Pub. Date: Oct. 26, 2006

(54) Process of using computer modeling, reconstructive modeling and simulation modeling for image guided reconstructive surgery

(76) Inventors: Joseph H. Piatt, Merion Station, PA (US); Binil Starly, Philadelphia, PA (US); Wei Sun, Cherry Hill, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/373,009

(22) Filed: Mar. 10, 2006

Related U.S. Application Data
(60) Provisional application No. 60/660,185, filed on Mar. 10, 2005.

(51) Int. Cl. G06K 9/40

(52) U.S. Cl. 382/254

(57) ABSTRACT

The invention provides both a quantitative and qualitative real time assessment of the surgical procedures in a method of image guided reconstructive surgery using computer modeling and simulation modeling.

### BACKGROUND OF THE INVENTION

1. Field of the Invention

This invention relates to image reconstruction, specifically it relates to image reconstruction for medical procedures.

2. Description of Related Art

The standard practice in hospital environments is to use a rapid prototyping model as a surgical planning tool and as a visual template for the reconstruction procedure.

The current practice of using a physical model for qualitative assessment and planning does not provide surgeons with a real time judgment. Often, the surgeon has to rely on his skills and experience to assess his surgical reconstruction. Such practice is prone to errors.

Computer-aided surgery apparatuses and methods have been disclosed by U.S. Pat. No. 5,251,127 to Raab, U.S. Pat. No. 5,871,018 to Delp, et al., and U.S. Pat. No. 6,711,432 to Krause et al. Methods for making medical models based on digital images of a part of the body have been disclosed by U.S. Pat. No. 5,741,215 to D'Urso, and U.S. Pat. No. 5,768,134 to Swaelens et al.

Despite the foregoing developments there is still a need for improved methods of image reconstruction.

All references cited herein are incorporated herein by reference in their entireties.

### BRIEF SUMMARY OF THE INVENTION

The object of the invention is to introduce a new tool that would aid surgeons in reconstructive surgery, preferably, in craniofacial reconstruction. Current clinical procedures in craniofacial reconstructive surgery rely on qualitative and semi-quantitative judgments by the surgeons about the adequacy of their work. There are many impediments to a visual assessment of the reconstruction procedure, and the surgeon's intraoperative judgments are often overturned on later review in the office or clinic. Quantitative, real time image guidance would serve as a valuable quality control for reconstructive procedures.

This invention provides a qualitative as well as a quantitative process of measuring and hence minimizing the errors which may occur during the process. The image data set from the virtually reconstructed model can be used as the template to achieve near to perfect reconstruction.

This invention has utility in medicine, e.g., reconstructive craniofacial surgery, cosmetic surgery, orthopaedic surgery, making medical prototypes, orthodontics, prostheses and surgical tools, as well as in non-medicinal applications in which precision of reconstructed images is desired.

The advantages of this invention include, for example, real time quantitative assessment of surgical procedure and the ease of incorporation within any hospital environment over currently used methods.

Bioinformatic models represented in the form of a 3-dimensional virtual computer model or in the form of an actual physical prototype are used as a planning tool for reconstructive surgery in, for example, neurosurgery, orthopedic surgery, and craniofacial plastic surgery. To date craniofacial reconstructive surgery has exploited the bioinformatic model in qualitative terms only. The ability for a surgeon to have a real time quantitative assessment will aid the judgment during the surgical procedure without relying on past experiences. Hence, such processes involve proficiency in both technical as well as artistic creativity skills. The image guided reconstructive surgery method of this invention aims at reducing the artistic component in such surgical procedures allowing correcting deviations from the reconstructed template in real time. Discrepancies between the planning performed at the CAD workstation and the actual surgical execution can be detected and corrected on the spot. The image guided reconstructive surgical method of the invention provides a surgeon with a tool aimed in reducing surgical errors and thereby increase the rate of successful reconstructive procedures with minimal post operative treatments.

This invention provides a real time quantitative assessment of surgical procedure without relying on surgeon's judgment or artistic skills. This method can be incorporated into any hospital environment.

Accordingly, the invention provides a method of reconstructive imaging, the method comprising providing a quantitative control of at least one parameter of a reconstructed image of an object.

Further, the invention provides a method of image guided reconstructive surgery using computer modeling and simulation modeling, the method comprising:

obtaining a computed tomographic image of an object in need of a surgery;

obtaining a reconstructed image of a 3D voxel model of the object using an image processing software;

obtaining a computed tomographic image of a model object;

obtaining a reconstructed image of a 3D voxel model of the model object using the image processing software;

comparing the reconstructed image of a 3D voxel model of the object and the reconstructed image of a 3D voxel model of the model object at a time of the surgery;

providing a feedback to a surgeon during the surgery, wherein the comparison of reconstructed images is used as a quantitative tool and a qualitative tool to provide a quantitative and qualitative control of at least one parameter of the reconstructed image of the object.

In certain embodiments, obtaining the computed tomographic image of the object in need of the surgery is performed continuously and contemporaneously with the surgery.

Also, the invention provides an improvement in a process of using computer modeling for image guided reconstructive surgery, the improvement comprising:

obtaining a comparison of a reconstructed image of a 3D voxel model of an object in need of a surgery with a reconstructed image of a 3D voxel model of a model object using an image processing software, wherein the comparison is obtained continuously and contemporaneously with a surgery; and

providing a feedback to a surgeon during the surgery, wherein the comparison of reconstructed images is used as a quantitative tool and a qualitative tool to provide a quantitative and qualitative control of at least one parameter of the reconstructed image of the object.

### BRIEF DESCRIPTION OF SEVERAL VIEWS OF THE DRAWINGS

The invention will be described in conjunction with the following drawings in which like reference numerals designate like elements and wherein:

FIG. 1A is a flow chart of an image guided process of the invention.

FIG. 1B is a flow chart of a visual reconstruction process.

FIG. 2A is an image of a data set fusion of original data set with the reconstructed data set.

FIG. 2B demonstrates sample images in MIMICS.

FIG. 2C demonstrates reconstructed views of the deformed skull.

FIG. 2D demonstrates virtual reconstruction in GEOMAGICS®.

FIG. 3 depicts photographs of fabricated physical models.

FIG. 4 is a flowchart demonstrating a prototype fabrication using ZCorp 402 machine.

FIGS. 5A-5D are pictures of clinical procedures demonstrating using the method of the invention.

### DETAILED DESCRIPTION OF THE INVENTION

Critical to the success of craniofacial surgery is the surgeon's accurate perception of the anatomy of the deformity. Recent advances in computer aided design and manufacturing have made it possible to capture details of the anatomical structures of the human body in the form of 3D computer models or actual physical prototypes. To date craniofacial reconstructive surgery has exploited the computer model in only qualitative terms. The goal of the invention presented herein is to harness the full power of modern computed imaging technologies for quantitative control of reconstructive procedures, such as, for example, craniofacial reconstructive procedures.

The invention provides both a quantitative and qualitative real time assessment of the surgical procedures. Computed tomographic (CT) images of the patient's skull are obtained and a 3D voxel model of the patient is reconstructed using medical image processing software. A virtual reconstruction of the patient's deformed skull is performed using standard tools available. The virtual reconstructed model can now be used as both a quantitative and qualitative tool using the following processes. The virtual model can be prototyped using commercially available prototyping systems. The physical model now provides the surgeon with a surgical planning tool as well as provides for qualitative assessment during surgical procedure for comparison. The physical model in the next step is CT scanned to produce an image data set of the reconstructed skull. The new image data set is overlapped with the original deformed CT data set to produce differences that can be seen and measured. This real time measurement can be done in the surgery room using commercially available image guided surgical systems. In the case that physical models cannot be made from virtual models, we provide an alternative approach by which the virtual model is sliced to obtain an image format commonly used in hospital environments. In the operating room, at the time of the surgical procedure, the original imaging data set is registered with the patient's deformed anatomy. As the operation proceeds, the actual reconstruction can be checked against the virtually reconstructed data set. Thus the surgeon can verify each step of his procedure in real time providing him with a quantitative assessment of his surgical procedure.

A non-limiting example of the method of the invention will now be described.

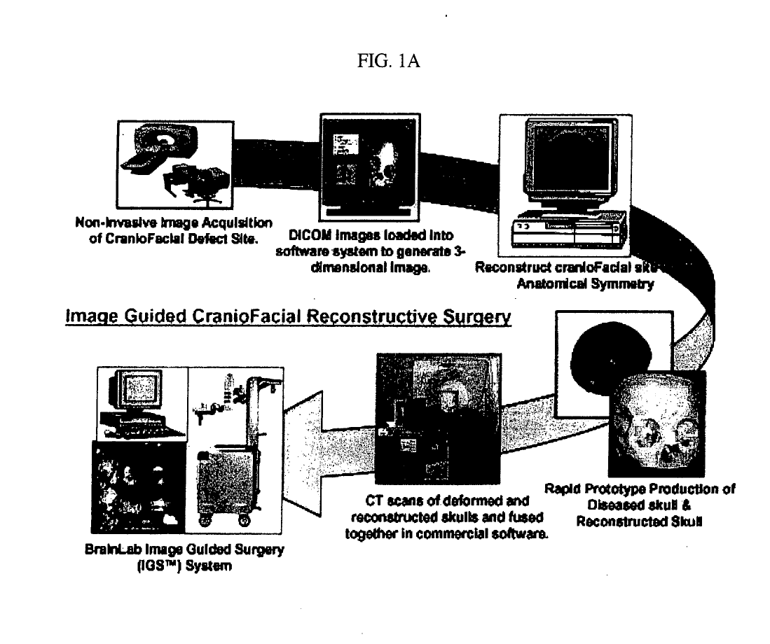

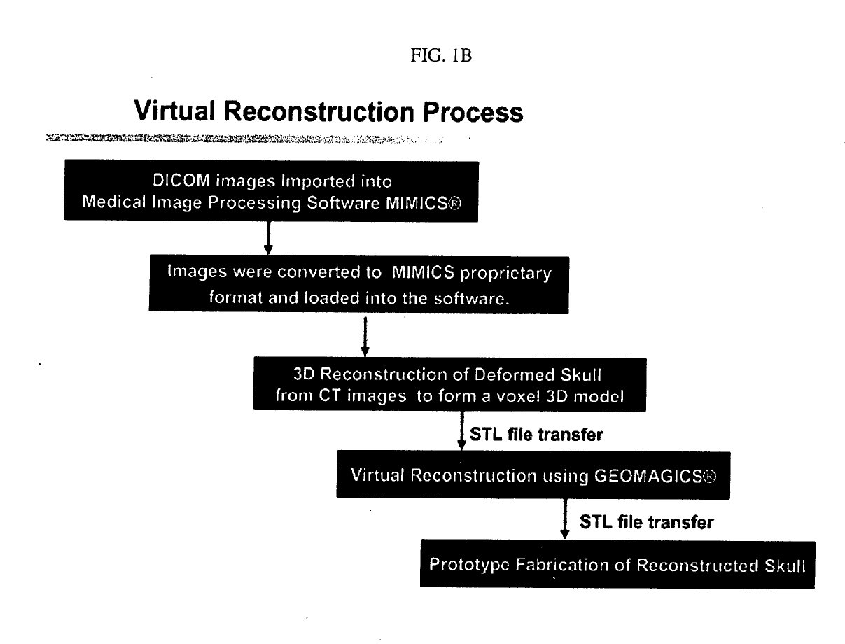

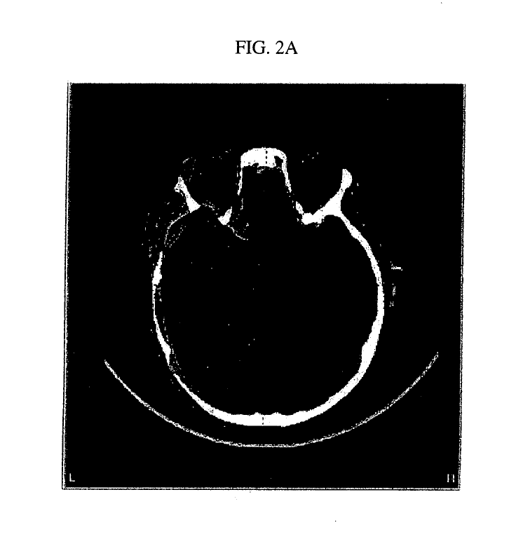

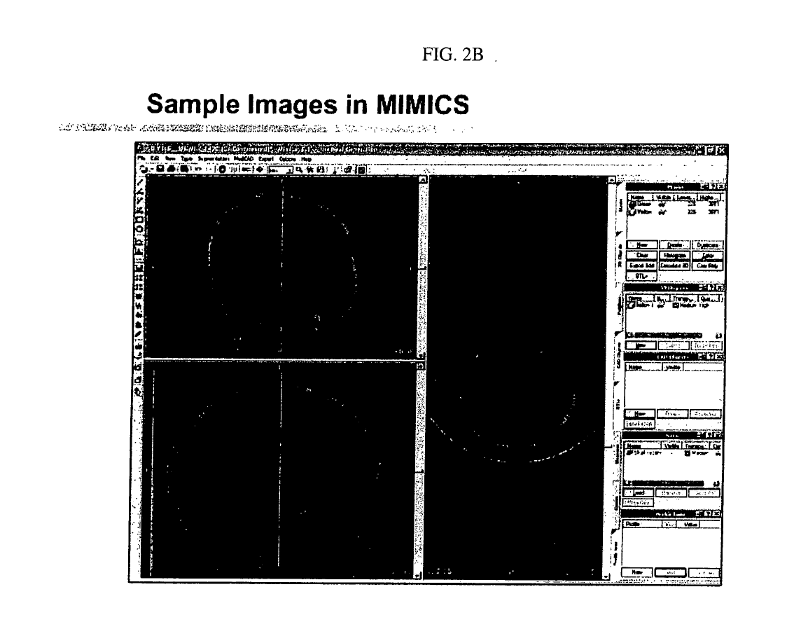

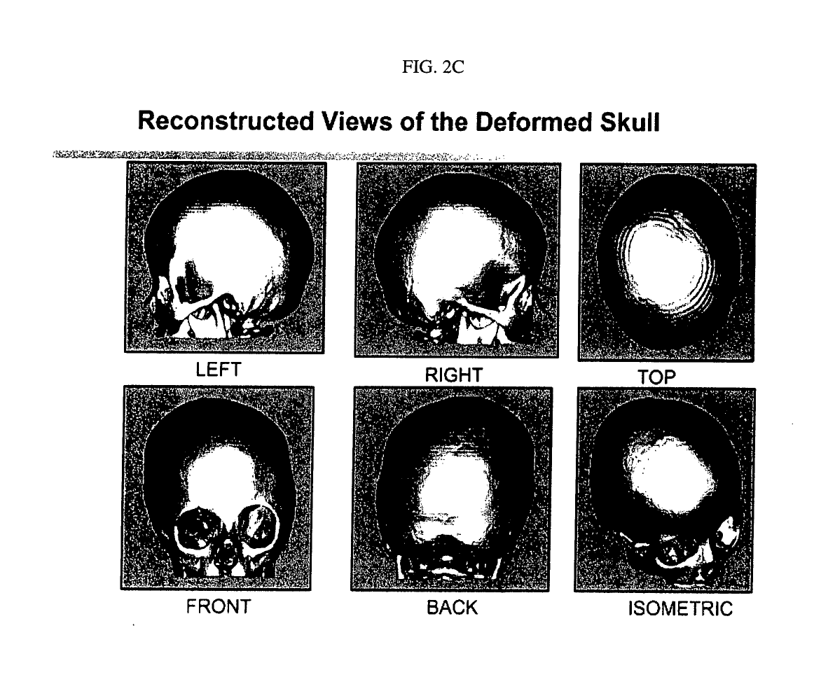

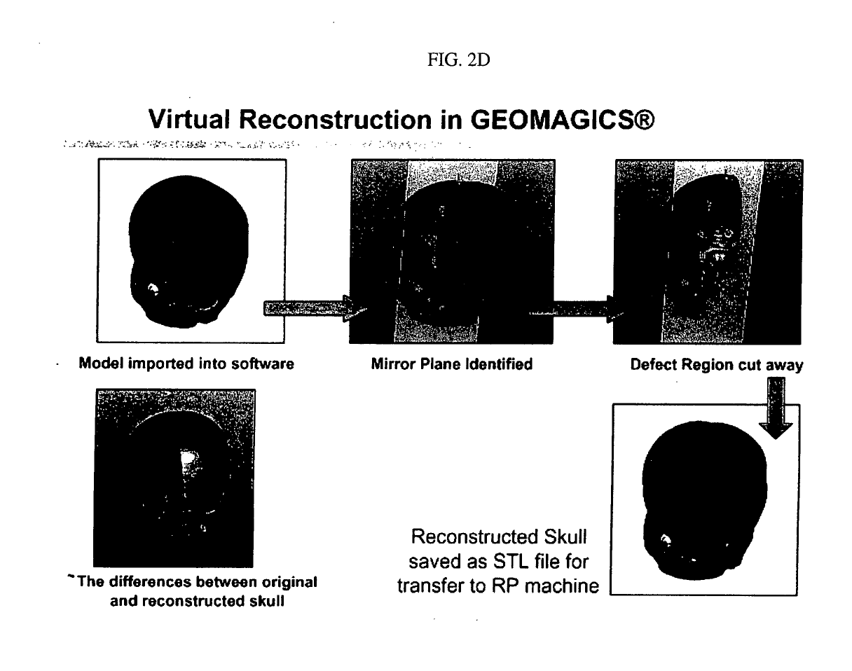

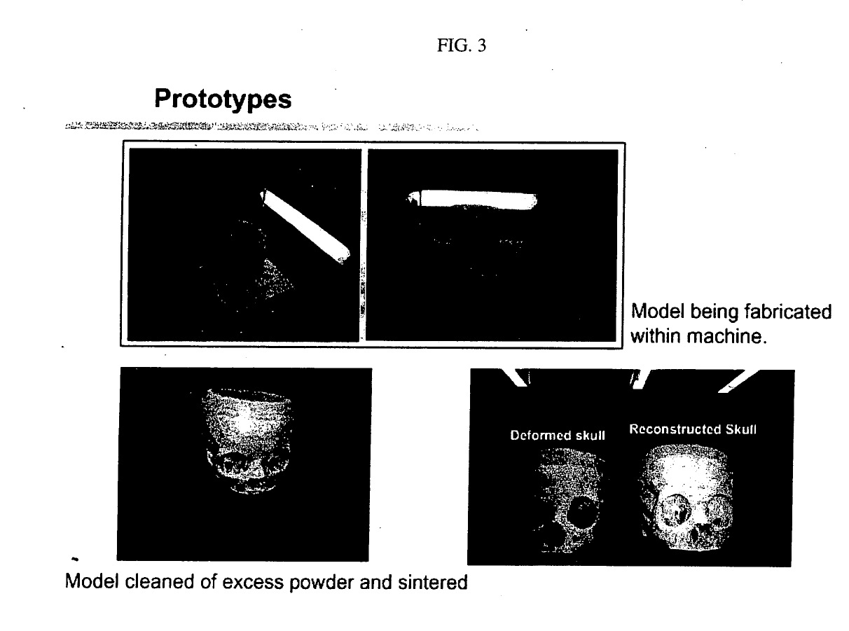

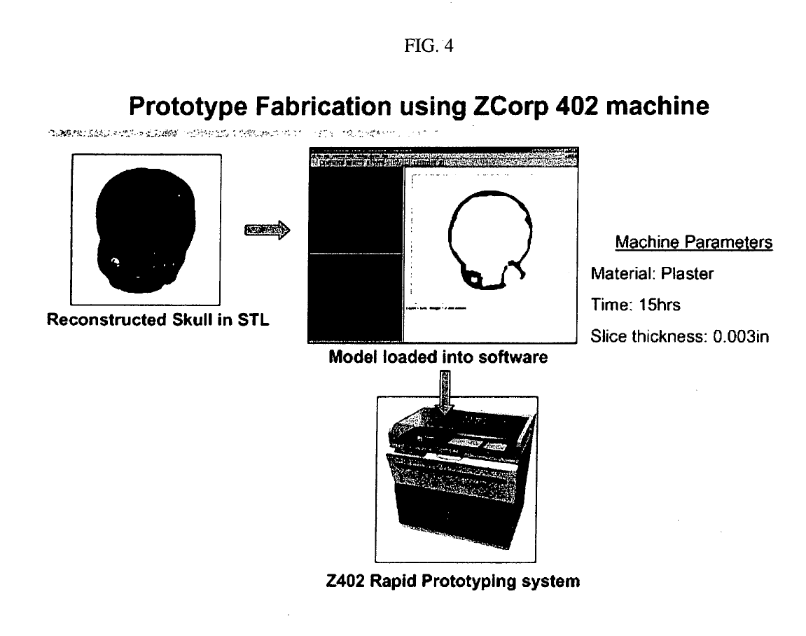

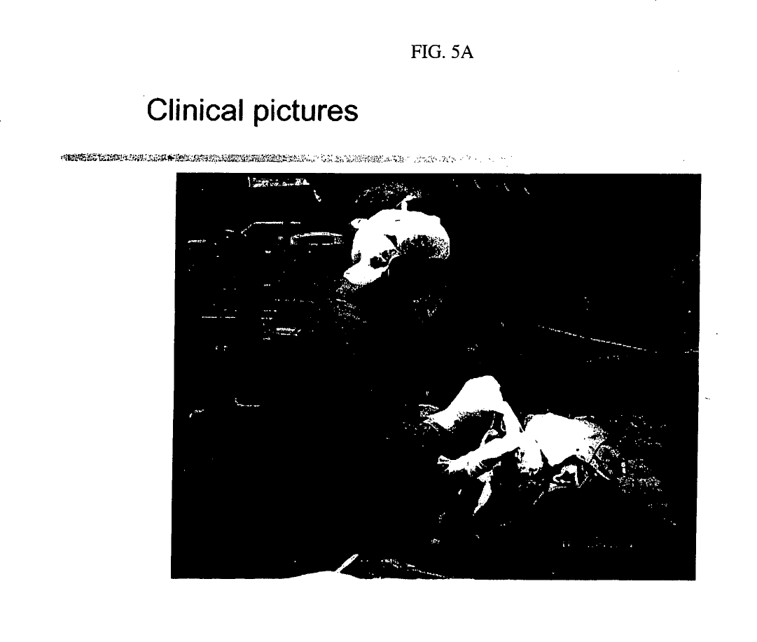

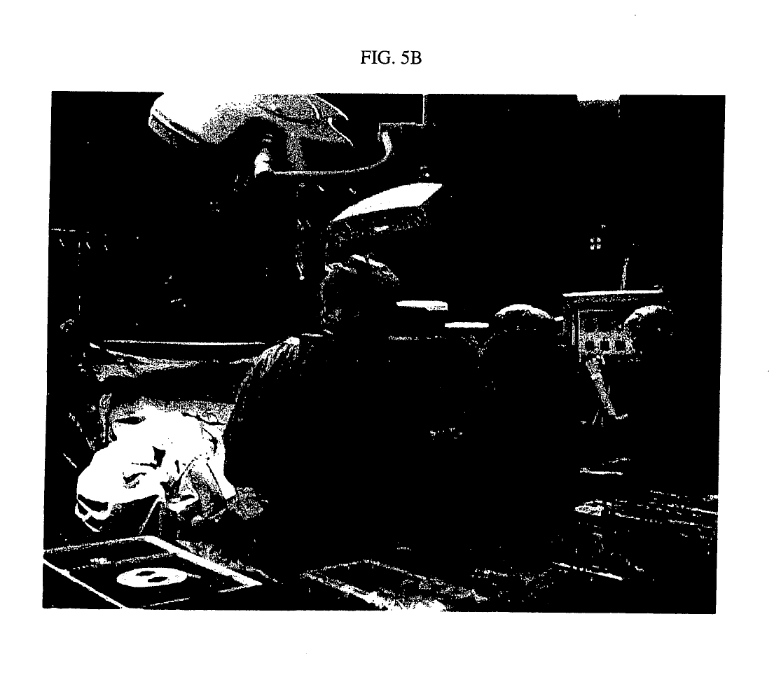

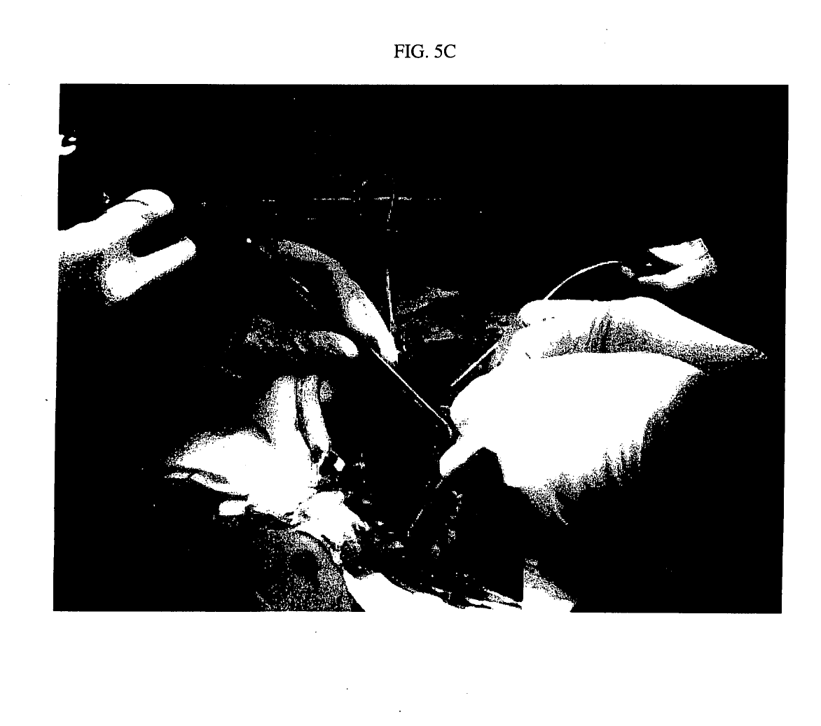

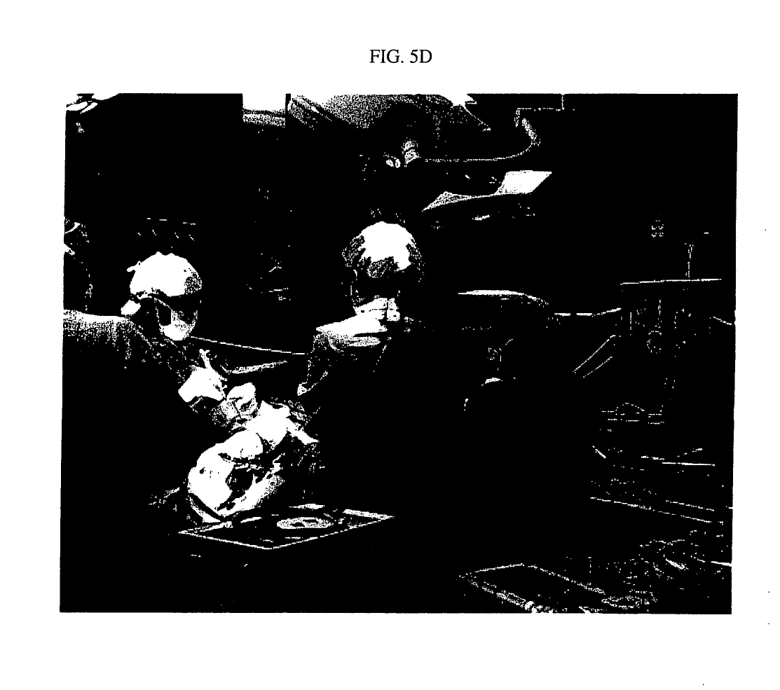

Computed tomographic (CT) images of the patient's skull are obtained and used to construct a 3D model of the deformity using MIMICS software (MATERIALISE NV, Belgium). Using this model as a starting point, virtual reconstructive surgery is performed using Geomagics (Raindrops), after which both the deformed and reconstructed skulls are fabricated using a Z-Corp 3D Rapid Prototyping system (Z Corporation, Burlington, Mass.). The reconstructed skull is then CT scanned. Employing the proprietary software of the BrainLab® (Munich, Germany) surgical image guidance system, the virtually reconstructed image data set can be superimposed or “fused” with the original data set. The BrainLab® system then enables the surgeon to verify each step of the reconstruction procedure in real time, and discrepancies from the actual and the ideal can be corrected at the region of deviation. A case example is presented (see FIGS. 1A-5D). The method of the invention provides quantitative as well as qualitative real time guidance for quality control functions during reconstructive surgery and can be incorporated within any hospital environment.

Threshold, Region Grow and 3D Reconstruction includes the following steps:
Find appropriate Threshold # to distinguish bone features from surrounding tissue (trial & error method).
Identify Region of Interest (ROI) within images.
Begin Region growing by picking within ROI in a CT slice. This operation first connects pixels together in a single selected CT slice and then grows to slices above and below it. All pixels are connected to form voxels.
The voxels in turn are reorganized, smoothed to form a Three-Dimensional Representation of the ROI.

While the invention has been described in detail and with reference to specific examples thereof, it will be apparent to one skilled in the art that various changes and modifications can be made therein without departing from the spirit and scope thereof.

What is claimed is:

1. A method of reconstructive imaging, the method comprising providing a quantitative control of at least one parameter of a reconstructed image of an object.

2. A method of image guided reconstructive surgery using computer modeling and simulation modeling, the method comprising:
obtaining a computed tomographic image of an object in need of a surgery;
obtaining a reconstructed image of a 3D voxel model of the object using an image processing software;
obtaining a computed tomographic image of a model object;
obtaining a reconstructed image of a 3D voxel model of the model object using the image processing software;
comparing the reconstructed image of a 3D voxel model of the object and the reconstructed image of a 3D voxel model of the model object at a time of the surgery;
providing a feedback to a surgeon during the surgery, wherein the comparison of reconstructed images is used as a quantitative tool and a qualitative tool to provide a quantitative and qualitative control of at least one parameter of the reconstructed image of the object.

3. The method of claim 2, wherein obtaining the computed tomographic image of the object in need of the surgery is performed continuously and contemporaneously with the surgery.

4. In a process of using computer modeling for image guided reconstructive surgery, the improvement comprising:
obtaining a comparison of a reconstructed image of a 3D voxel model of an object in need of a surgery with a reconstructed image of a 3D voxel model of a model object using an image processing software, wherein the comparison is obtained continuously and contemporaneously with a surgery; and
providing a feedback to a surgeon during the surgery, wherein the comparison of reconstructed images is used as a quantitative tool and a qualitative tool to provide a quantitative and qualitative control of at least one parameter of the reconstructed image of the object.
